(19) United States
(12) Patent Application Publication
(10) Pub. No.: US 2026/0231254 A1
(43) Pub. Date: Aug. 6, 2026

(54) SYSTEM AND METHOD TO HANDLE SLICE DEREGISTRATION INACTIVITY TIMER OF ON-DEMAND S-NSSAIS

(71) Applicant: Samsung Electronics Co., Ltd., Suwon-si, Gyeonggi-do (KR)

(72) Inventors: Danish Ehsan HASHMI, Bangalore (IN); Jagadeesh GANDIKOTA, Bangalore (IN); Lalith KUMAR, Bangalore (IN); Koustav ROY, Bangalore (IN); Ashok Kumar NAYAK, Bangalore (IN)

(21) Appl. No.: 19/157,098

(22) PCT Filed: Feb. 14, 2024
(86) PCT No.: PCT/KR2024/095116

§ 371 Date: Aug. 15, 2025

(30) Foreign Application Priority Data
Feb. 17, 2023 (IN) 202341011011
Jan. 31, 2024 (IN) 202341011011

(51) Int. Cl. H04W 76/12; H04W 48/18; H04W 76/38

(52) U.S. Cl. CPC H04W 76/12; H04W 48/18; H04W 76/38

(57) ABSTRACT

The disclosure relates to a 5G or 6G communication system for supporting a higher data transmission rate. Embodiments disclosed herein provide a method for handling slice Deregistration Inactivity timer of on-demand S-NSSAI in a telecommunication network (1000) by a UE (100). The method includes determining whether a MA PDU session is successfully established. In an embodiment, the method includes avoiding to start a slice de-registration inactivity timer in the UE and an AMF entity (200) on any access type, when the MA PDU session is successfully established. In another embodiment, the method includes starting the slice deregistration inactivity timer for the on-demand S-NSSAI over a corresponding access type, when the MA PDU session is not successfully established.

### TECHNICAL FIELD

The present disclosure relates to the field of a telecommunication network, and more particularly, to a method and the telecommunication network to handle a slice Deregistration Inactivity timer and a PDU Session Inactivity Timer of on-demand S-NSSAIs.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies,

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to provide a method and system to handle Slice Deregistration Inactivity timer and PDU Session Inactivity timer of on-demand S-NSSAIs.

Another object of the embodiments herein is to provide that the UE does not start slice de-registration inactivity timer in the UE and the AMF on any access if the MA PDU session is successfully.

Another object of the embodiments herein is to determine that PDU session inactivity timer shall be common in case of MA PDU session. When the MA PDU session is established, the network apparatus shall not start PDU session inactivity timer when data is received on any access.

### Solution to Problem

Embodiments disclosed herein provide a method for handling slice Deregistration Inactivity timer of on-demand S-NSSAI in a telecommunication network. The method includes determining, by a UE, whether a MA PDU session is successfully established. In an embodiment, the method includes avoiding to start a slice de-registration inactivity timer in the UE and an AMF entity on any access type, when the MA PDU session is successfully established. In another embodiment, the method includes starting the slice deregistration inactivity timer for the on-demand S-NSSAI over a corresponding access type, when the MA PDU session is not successfully established.

Embodiments disclosed herein provide a method for handling an slice Deregistration Inactivity timer of an on-demand S-NSSAI in a telecommunication network. The method includes determining, by a network apparatus, that a PDU session inactivity timer is common in case of a MA PDU session. Further, the method includes determining, by the network apparatus, that the MA PDU session is established. Further, the method includes avoiding to start, by the network apparatus, the PDU session inactivity timer when data is received on any access type in response to determining that the PDU session inactivity timer is common in case of the MA PDU session and the MA PDU session is established.

In an embodiment, the network apparatus is one of an AMF entity and a SMF entity.

Embodiments disclosed herein provide a UE for handling slice Deregistration Inactivity timer of on-demand S-NSSAI in a telecommunication network. The UE includes a slice Deregistration Inactivity timer handling controller coupled to a memory and a processor. The slice Deregistration Inactivity timer handling controller is configured to determine whether a MA PDU session is successfully established. In an embodiment, slice Deregistration Inactivity timer handling controller is configured to avoid to start a slice de-registration inactivity timer in the UE (100) and an AMF entity on any access type, when the MA PDU session is successfully established. In another embodiment, slice Deregistration Inactivity timer handling controller is configured to start the slice deregistration inactivity timer for the on-demand S-NSSAI over a corresponding access type, when the MA PDU session is not successfully established.

Embodiments disclosed herein provide a network apparatus for handling a slice Deregistration Inactivity timer of an on-demand S-NSSAI in a telecommunication network. The network apparatus includes a slice Deregistration Inactivity timer handling controller coupled to a memory and a processor. The slice Deregistration Inactivity timer handling controller is configured to determine that a PDU session inactivity timer is common in case of a MA PDU session. Further, the slice Deregistration Inactivity timer handling controller is configured to determine that the MA PDU session is established. Further, the slice Deregistration Inactivity timer handling controller is configured to avoid to start the PDU session inactivity timer when data is received on any access type in response to determining that the PDU session inactivity timer is common in case of the MA PDU session and the MA PDU session is established.

In an embodiment, the method includes starting, by the UE, the slice Deregistration Inactivity timer on a source access associated with the S-NSSAI when the last PDU session of an on demand S-NSSAI has been successfully handover or attempted to be handed over to a target Access type of a core network.

In an embodiment, the method includes initiating, by the UE, a handover of a PDU session procedure to handover a PDU session from a source network access to a target network access by sending a NAS signalling message with a request type as “existing PDU Session” to the AMF entity. Further, the method includes receiving, by the UE, an accept message corresponding to the PDU Session handover by sending as NAS message from the AMF entity. Further, the method includes stopping, by the UE, the slice inactivity de-registration timer if running for on-demand S-NSSAI on the target access type, once the handover of the PDU session for an on-demand S-NSSAI is successful.

In an embodiment, the method includes starting, by the network apparatus, the slice Deregistration Inactivity timer on a source access associated with S-NSSAI when the last PDU session of an on demand S-NSSAI has been successfully handover or attempted to be handed over to another target Access type of a core network.

In an embodiment, the method includes sending, by the network apparatus, an accept message corresponding to a PDU Session handover by sending as NAS message to the UE when the UE initiates the handover of a PDU session procedure to hand over a PDU session from a source network access to a target network access by sending a NAS signalling message with a request type as “existing PDU Session” to the network apparatus. Further, the method includes stopping, by the network apparatus, the slice inactivity de-registration timer if running for on-demand S-NSSAI on the target access type, once the handover of the PDU session for an on-demand S-NSSAI is successful.

In an embodiment, the UE and the AMF entity shall start the slice Deregistration Inactivity timer on source access associated with S-NSSAI once the last PDU session of an on demand S-NSSAI has been successfully handover or attempted to be handed over to another target Access type or RAT or PLMN or another network instance of core network.

In an embodiment, the UE initiates handover of PDU session procedure to hand over the PDU session from one network access (source access) to another network access (target access, e.g., 3GPPA to N3GPPA), by sending a NAS signalling message such PDU Session Establishment Request with request type as “Existing PDU Session”, Network entity such as for example SMF entity (300), Accepts the PDU Session handover by sending as NAS message such as PDU Session Establishment Accept. Solution: the AMF entity/the UE shall stop the slice inactivity de-registration timer if running for on demand S-NSSAI on the target access type/ PLMN/RAT/Network entity, once a hand over of PDU session for an on-demand S-NSSAI is successful.

Other aspects of the embodiments herein are better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

According to an embodiment of present disclosure, a terminal can efficiently perform a communication.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates Slice Deregistration Inactivity timer not started for Handover of a PDU Session procedure;

FIG. 2 illustrates Slice Deregistration Inactivity timer and removal of the S-NSSAI1 from allowed NSSAI list after timer expiry;

FIG. 3 illustrates Slice Deregistration Inactivity timer/PDU Session inactivity timer during change of AMF entity/SMF entity;

FIG. 4 illustrates Slice Deregistration Inactivity timer running for MA PDU session;

FIG. 5 illustrates PDU session Inactivity timer running for MA PDU session;

FIG. 6 illustrates UE/AMF entity shall start the slice Deregistration Inactivity timer once the last PDU session of an on demand S-NSSAI has been successfully handover to another Access type or RAT or PLMN, according to an embodiment disclosed herein;

FIG. 7 illustrates proposed solution AMF entity/UE shall stop the inactivity de-registration timer if running on the target access type/PLMN/RAT/Network entity(network function), according to an embodiment disclosed herein;

FIG. 8 illustrates proposed solution slice Deregistration Inactivity timer or PDU session inactivity timer and may notifies the UE, according to an embodiment disclosed herein;

FIG. 9 illustrates proposed solution for Slice Deregistration Inactivity timer not running for MA PDU session, according to an embodiment disclosed herein;

FIG. 10 illustrates PDU session Inactivity timer not running for MA PDU session, according to an embodiment disclosed herein;

FIG. 11 illustrates Slice Deregistration Inactivity timer running for MA PDU session, according to an embodiment disclosed herein;

FIG. 12 shows various hardware components of the UE, according to the embodiments as disclosed herein;

FIG. 13 shows various hardware components of a network apparatus, according to the embodiments as disclosed herein;

FIG. 14 is a flow chart illustrating a method, implemented by the UE, for handling the slice Deregistration Inactivity timer of on-demand S-NSSAIs in a telecommunication network, according to the embodiments as disclosed herein.

FIG. 15 is a flow chart illustrating a method, implemented by the network apparatus, for handling the slice Deregistration Inactivity timer of on-demand S-NSSAIs in the telecommunication network, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

In general, a network can configure slice-specific polices, more specifically, it is proposed to use Policy Control Function (PCF) or local AMF configuration/policy for handling network policies related to S-NSSAIs subject to network control during a registration procedure or UE configuration update procedure. The policies can include one or more of the following components: whether a registration for the S-NSSAI needs to be performed based on demand or usage (application require data transmission on the S-NSSAI) or configuration. An indication is configured by an HPLMN and/or Visited Public Land Mobile Network (VPLMN) (if authorized by the HPLMN, based on e.g. Unified data management (UDM) indication) and can be provided via existing User Equipment (UE) configuration update procedures (for example together with the configured NSSAI). An slice de-registration inactivity timer is provided, after a slice is implicitly deregistered if no PDU sessions are present on the respective slice. The deregistration applies only for slices that are on-demand. The timer runs at both the UE and the Access Management Function (AMF) entity. The timer is provided by the HPLMN or the VPLMN (AMF policy) during the registration procedure or UE con-figuration update procedure together with the Configured NSSAI. The timer can be per S-NSSAI.

The AMF entity determines to deregister the network slice S-NSSAI if no PDU session is using the slice S-NSSAI for a determined network slice deregistration time which runs at the AMF entity and the UE. An SMF entity determines to release the Protocol Data Unit (PDU) session if no user data is sent over the PDU session for a determined PDU session inactivity timer which runs only at the SMF entity/an UPF entity. The AMF entity may also remove the S-NSSAI from the allowed NSSAI based on indication from the SMF entity after completion of the PDU Session Release procedure if it does not find any other PDU session for the same slice (S-NSSAI) over related access type.

The PDU session inactivity timer, which cause the release of the PDU session if no data was transmitted or received for the duration of the inactivity timers, or the network slice deregistration timer which cause the removal of a given S-NSSAI from an Allowed NSSAI after the last PDU session in the network slice was released, may be set by authorized AF (if the PLMN allows and for slices solely dedicated for the AF and not shared with others) and stored in the network (e.g. UDM or PCF per S-NSSAI/DNN. The timer from network can be obtained by the AMF entity and the SMF entity respectively at the time of UE registration and PDU session establishment. For EPS case, the PDN connections have similar handling to PDU sessions in a 5GS.

The UE, during the registration procedure, may indicate in UE MM Core Network Capability that it supports UE configuration of network-controlled Slice Usage Policy (SUP). If so, the AMF entity determines SUP for a network slice for the UE and may configure the UE with this information together with configured NSSAI to control the usage of this network slice. The AMF entity may be locally configured with network Slice Usage Policy or receive the policy from the (AM) PCF.

The network-controlled Slice Usage Policy is provided to the UE in the Registration Accept or the UE Configuration Update Command and may include: an indication, for one or more of S-NSSAI(s) of the HPLMN in the Configured NSSAI, whether the UE needs to register the network slice with the network when applications in the UE require data transmission in the network slice (i.e. the UE needs to register the network slice only on demand).

Please note that all Other network slices in the Configured NSSAI are handled by the UE using UE specific policies (e.g. they can be registered irrespective of applications need). For all on demand S-NSSAI(s) of the HPLMN in the Configured NSSAI, the slice deregistration inactivity timer that causes the UE to deregister the network slice after the last PDU Session associated with the S-NSSAI is released. This slice deregistration inactivity timer is started at the UE and the AMF entity per access type when the last PDU Session associated with the on demand S-NSSAI is released, or the network slice is included in the Allowed NSSAI and no PDU session is established. The deregistration inactivity timer is stopped and reset when the first PDU session is established or the S-NSSAI is removed from the Allowed NSSAI. The AMF entity and UE may locally remove the S-NSSAI from the Allowed NSSAI when the timer expires. The AMF entity may also send a UE Configuration Update Command to remove the slice from the Allowed NSSAI.

The 5GC performs usage monitoring to be able to enforce the release of inactive PDU Sessions, and deregistering of UEs from network slices with no PDU Sessions on them according to the policies. In order to support usage monitoring for a UE the AMF entity runs a slice deregistration inactivity timer per S-NSSAI and access type to deregister the network slice which is started when the network slice is not used by any PDU Session over the corresponding access type. The deregistration inactivity timer is stopped and reset when at least a PDU Session associated with the network slice is successfully established or the network slice is removed from the Allowed NSSAI. When the deregistration inactivity timer for a network slice over an access type expires, the AMF entity removes the network slice from the Allowed NSSAI over the access type by sending the UE Configuration Update Command to impacted UE(s).

The SMF entities provide to UPFs that handle the PDU sessions in the network slice a PDU Session inactivity timer. The PDU Session inactivity timer is started after no data packet is transmitted or received and runs until the next data packet is transmitted or received which restarts the timer again. If the PDU Session inactivity timer expires before any packet is received or transmitted, the UPF reports this PDU Session inactivity event to the SMF entity to cause the SMF entity to release the PDU Session. When the AMF entity receives the notification of PDU Session release and it includes the indication of network slice removal and if the network slice of the released PDU Session is not used by other PDU Sessions (i.e. the last PDU Session using the network slice is released) over the corresponding access type, the AMF entity may trigger the UE Configuration Update procedure to remove the network slice from the Allowed NSSAI over that corresponding access type.

The deregistration inactivity and PDU Session inactivity timers are either pre-configured in the AMF entity/SMF entity or received from the PCF/UDM.

The above information is presented as background information only to help the reader to understand the present invention. Applicants have made no determination and make no assertion as to whether any of the above might be applicable as prior art with regard to the present application.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semi-conductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The term 5GMM sublayer states in this embodiment are at least one of the below:
1) 5GMM-NULL
2) 5GMM-DEREGISTERED
a) 5GMM-DEREGISTERED.NORMAL-SERVICE
b) 5GMM-DEREGISTERED.LIMITED-SERVICE
c) 5GMM-DEREGISTERED.ATTEMPTING-REGISTRATION
d) 5GMM-DEREGISTERED.PLMN-SEARCH
e) 5GMM-DEREGISTERED.NO-SUPI
f) 5GMM-DEREGISTERED.NO-CELL-AVAILABLE
g) 5GMM-DEREGISTERED.eCALL-INACTIVE
h) 5GMM-DEREGISTERED.INITIAL-REGISTRATION-NEEDED
3) 5GMM-REGISTERED-INITIATED
4) 5GMM-REGISTERED
a) 5GMM-REGISTERED.NORMAL-SERVICE
b) 5GMM-REGISTERED.NON-ALLOWED-SERVICE
c) 5GMM-REGISTERED.ATTEMPTING-REGISTRATION-UPDATE
d) 5GMM-REGISTERED.LIMITED-SERVICE
e) 5GMM-REGISTERED.PLMN-SEARCH
f) 5GMM-REGISTERED.NO-CELL-AVAILABLE
g) 5GMM-REGISTERED.UPDATE-NEEDED
5) 5GMM-DEREGISTERED-INITIATED
6) 5GMM-SERVICE-REQUEST-INITIATED
a) 5GMM-IDLE mode: In the specification, if the term is used standalone, a UE in 5GMM-IDLE mode means the UE can be either in 5GMM-IDLE mode over 3GPP access or in 5GMM-IDLE mode over non-3GPP access.
b) 5GMM-CONNECTED mode: In this specification, if the term is used standalone, a UE in 5GMM-CONNECTED mode means the UE can be either in 5GMM-CONNECTED mode over 3GPP access or in 5GMM-CONNECTED mode over non-3GPP access.
c) 5GMM-IDLE mode over 3GPP access: A UE is in 5GMM-IDLE mode over 3GPP access when no N1 NAS signalling connection between the UE and Network (i.e. Network function e.g. AMF entity/SMF entity/UPF entity) over 3GPP access exists. The term 5GMM-IDLE mode over 3GPP access used in the present document corresponds to the term CM-IDLE state for 3GPP access used in 3GPP TS 23.501.
d) 5GMM-CONNECTED mode over 3GPP access: A UE is in 5GMM-CONNECTED mode over 3GPP access when an N1 NAS signalling connection between the UE and Network (i.e. Network function e.g. AMF entity/SMF entity/UPF entity) over 3GPP access exists. The term 5GMM-CONNECTED mode over 3GPP access used in the present document corresponds to the term CM-CONNECTED state for 3GPP access used in 3GPP TS 23.501.

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The terms ““Slice Deregistration Inactivity timer” and “Inactivity Deregistration timer” are used interchangeably in the patent disclosure.

Embodiments disclosed herein provide a method for handling slice Deregistration Inactivity timer of on-demand S-NSSAI in a telecommunication network. The method includes determining, by a UE, whether a MA PDU session is successfully established. In an embodiment, the method includes avoiding to start a slice de-registration inactivity timer in the UE and an AMF entity on any access type (i.e. both 3GPP and non-3GPP access), when the MA PDU session is successfully established. In another embodiment, the method includes starting the slice deregistration inactivity timer for the on-demand S-NSSAI over a corresponding access type, when the MA PDU session is not successfully established. In an embodiment, MA PDU session not established include a case where MA PDU session was established and later released rendering no MA

In an embodiment, the UE does not start slice de-registration inactivity timer in the UE and the AMF on any access if the MA PDU session is successfully established.

In an embodiment, the AMF and the UE will start the slice deregistration inactivity timer for the on demand S-NSSAI if on both access at least one PDU session is not established for the case of MA-PDU session.

In an embodiment, the method determines that PDU session inactivity timer shall be common in case of MA PDU session. When the MA PDU session is established, the network apparatus shall not start PDU session inactivity timer when data is received on any access.

In an embodiment, every registration procedure, the UE and AMF entity adjusts the timer values. Registration procedure can be triggered by the UE for any of the triggers as defined in TS 24.501, the UE sends registration request, After executing the registration procedure, the AMF entity decides to send the registration accept message. The AMF entity stops the timer value and restarts with the new value. The new value AMF entity sends to the UE as part of registration accept message. When UE receives the registration accept message then UE should stop and restart the timer with the new value it receives in the registration accept message. In an embodiment, during handover of last PDU session from source to target access type/PLMN/RAT/Network entity, the timer shall be started on the source and stopped on the target if its running.

The following acronym used in the patent disclosure.
a) UE: User Equipment
b) UP: User Plane
c) AMF: Access and Mobility Management Function
d) SMF: Session Management Function
e) UPF: User Plane Function
f) PCF: Policy Control Function
g) PDU: Packet Data Unit
h) SR: Service Request
i) TAI: Tracking Area Identity
j) TAC: Tracking Area Code
k) 3GPPA: 3GPP Access
l) N3GPPA: Non 3GPP Access
m) 3GPP: 3rd generation partnership project
n) MA PDU: Multi Access-PDU
o) RAT: Radio Access Technology
p) DL: Downlink
q) NAS: Non Access Stratum

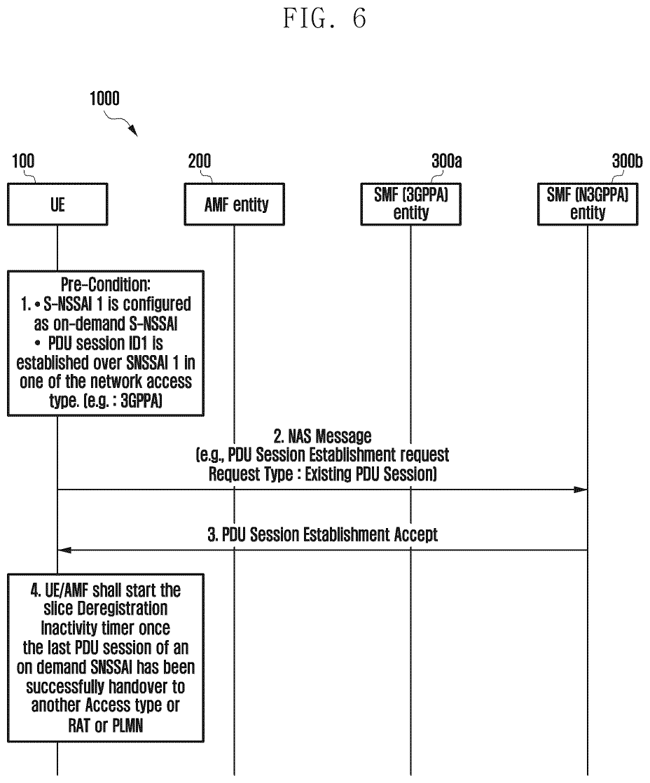

Referring now to the drawings, and more particularly to FIGS. 6 through 15, where similar reference characters denote corresponding features consistently throughout the figures, there are shown at least one embodiment.

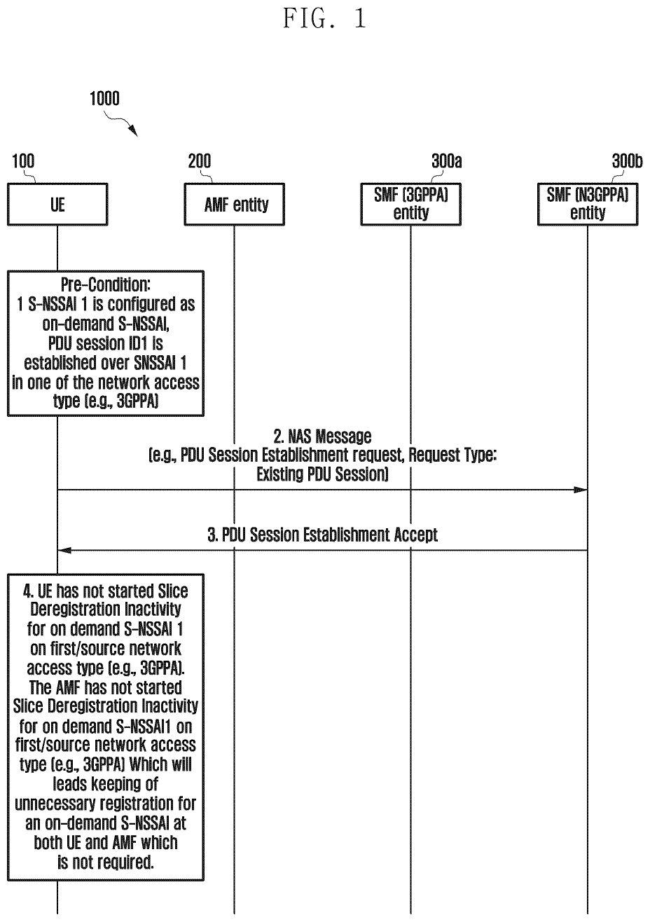

FIG. 1 illustrates slice Deregistration Inactivity timer not started for handover of a PDU session procedure.

At step 1, Pre-Condition: the UE (100) is registered over one/both of the Network access types such as 3GPP access (3GPPA) and non 3GPP access (N3GPPA) and established a PDU session (e.g., PDU Session ID1) over an on-demand S-NSSAI (e.g., S-NSSAI 1) over a access type such as 3GPPA UE initiated handover of PDU session procedure to hand over the PDU session from one network access to another network access (e.g., 3GPPA to N3GPPA), by sending a NAS signalling message such PDU Session Establishment Request with request type as “Existing PDU Session” Network entity such as for example the SMF entity (300b) at step 2. At step 3, the UE (100) accepts the PDU Session handover by sending as NAS message such as PDU Session Establishment Accept.

Issue: at step 4, UE (100) has transferred an Existing PDU session from one network access type to another network access type but
1. UE has not started Slice Deregistration Inactivity timer for on demand S-NSSAI1 on first/source network access type (e.g., 3GPPA).
2. The AMF entity has not started Slice Deregistration Inactivity timer for on demand S-NSSAI1 on first/source network access type (e.g., 3GPPA).
3. Which will leads keeping of unnecessary registration for an on-demand S-NSSAI at both UE (100) and AMF entity (200) which is not required.

Please note that the handover of a PDU Session in above example is given between 3GPP Access to Non 3GPP Access, the problem exists for all other cases such as:
1. Handover of a PDU session to non-3GPPA to 3GPPA,
2. Handover of a PDU session from 5G RAT to LTE RAT or another RAT or between any two RATs,
3. Handover of PDU session between AMF entity (200)/SMF entity (300a, 300b) of same or different PLMN, and
4. Handover procedure can be initiated by the UE (100) or it can be network initiated procedure.

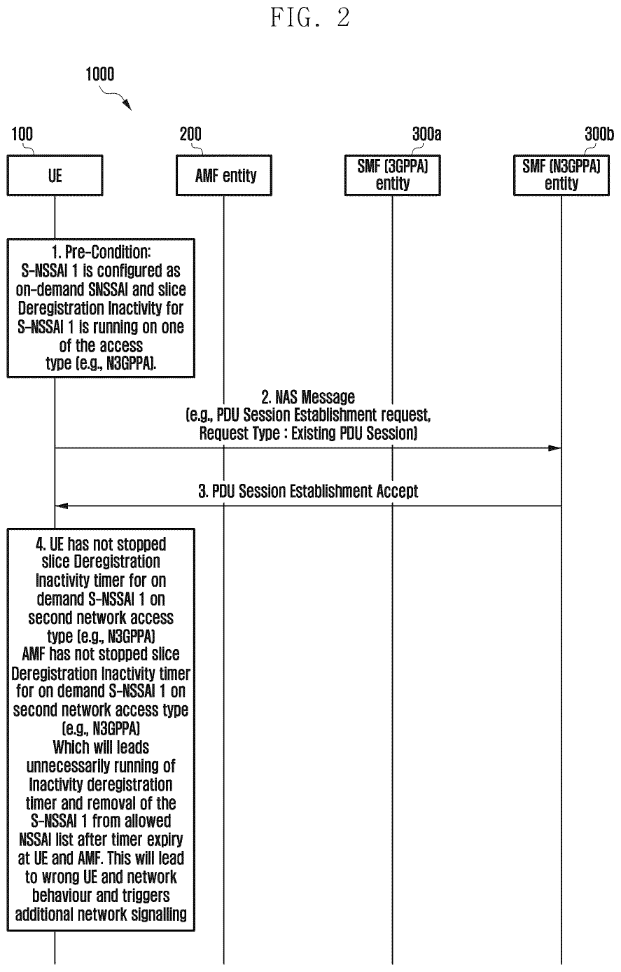

FIG. 2 illustrates the slice Deregistration Inactivity timer and removal of the S-NSSAI1 from allowed NSSAI list after timer expiry.

Pre-Condition: At step 1, the UE (100) is registered over one/both of the Network access types, and UE (100) running an slice Deregistration Inactivity timer on one of the network access type for an on demand S-NSSAI (e.g., S-NSSAI 1 over N3GPPA)

At step 2 and step 3, the UE (100) initiated handover of PDU session procedure to hand over the PDU session from one network access to another network access (e.g., 3GPPA to N3GPPA), by sending a NAS signalling message such PDU Session Establishment Request with request type as “Existing PDU Session”, Network entity such as for example SMF entity (300b), Accepts the PDU Session handover by sending as NAS message such as PDU Session Establishment Accept. Issue: at step 4, the UE (100) has transferred an Existing PDU session from one network access type to another network access type but
1. The UE has not stopped Slice Deregistration Inactivity timer for on demand S-NSSAI1 on second network access type (e.g., N3GPPA).
2. The AMF entity has not stopped Slice Deregistration Inactivity timer for on demand S-NSSAI1 on second network access type (e.g., N3GPPA).
3. Which will leads unnecessarily running of Slice Deregistration Inactivity timer and removal of the S-NSSAI1 from allowed NSSAI list after timer expiry at UE (100) and AMF entity (200). This will lead to wrong UE (100) and network behaviour and triggers additional network signalling.

Please note that the Handover of a PDU Session in above example is given between 3GPP Access to Non 3GPP Access, the problem exists for all other cases when an existing PDU session is transferred, such as
1. Handover of a PDU session from non-3GPPA to 3GPPA.
2. Handover of a PDU session from 5G RAT to LTE RAT or another RAT or between any two RATs.
3. Handover of PDU session between AMF entity (200)/SMF entity (300a, 300b) of same or different PLMN.
4. Handover procedure can be initiated by the UE (100) or it can be network initiated procedure.

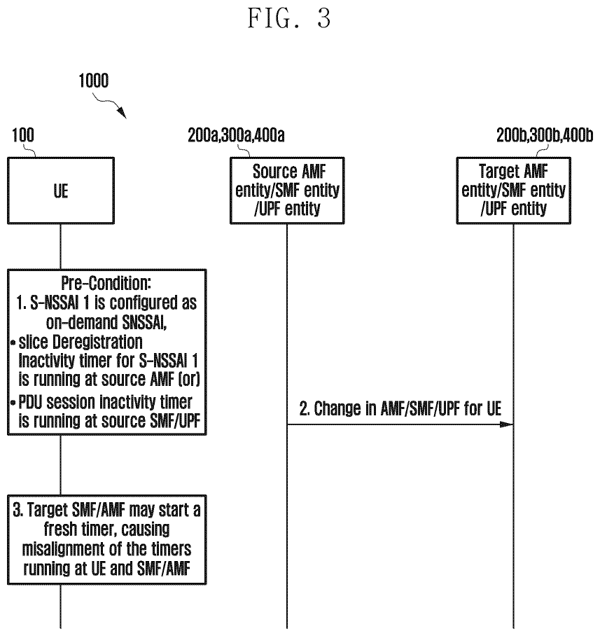

FIG. 3 illustrates Slice Deregistration Inactivity timer/PDU Session inactivity timer during change of AMF entity (200a, 200b)/SMF entity (300a, 300b).

Pre-Condition: At step 1, S-NSSAI 1 is configured as on-demand S-NSSAI at UE (100) and slice Deregistration Inactivity timer for S-NSSAI1 is running at source AMF entity (200a) and UE (100) (or) PDU session inactivity timer is running at source SMF entity (300a)/UPF entity (400a). At step 2, there is a Change in AMF entity (200)/UPF/SMF entity (300) that is serving the UE (100), Issue: At step 3, Target SMF entity (300b)/AMF entity (200b) may start a fresh timer or a timer reduced by the amount of the already elapsed timer, causing misalignment of the timers running at UE (100) and SMF entity (300a, 300b)/AMF entity.

Please note that the change of AMF entity (200a, 200b)/SMF entity (300a, 300b)/UPF entity (400a, 400b) can be on same network access or different network access type:
1. Change of PDU session from one SMF entity (300a)/UPF entity (400a) to another SMF entity (300b)/UPF entity (400b) can be for any reason like load balancing or change in S-NSSAI configuration or similar reason.
2. Change of AMF entity (200a, 200b) for a UE (100) can be any one of the reason like AMF entity (200a, 200b) relocation or load balancing or change in UE (100) location or result of registration request of type mobility.
3. Change of AMF entity (200a, 200b)/SMF entity (300a, 300b) is from same or different PLMN.

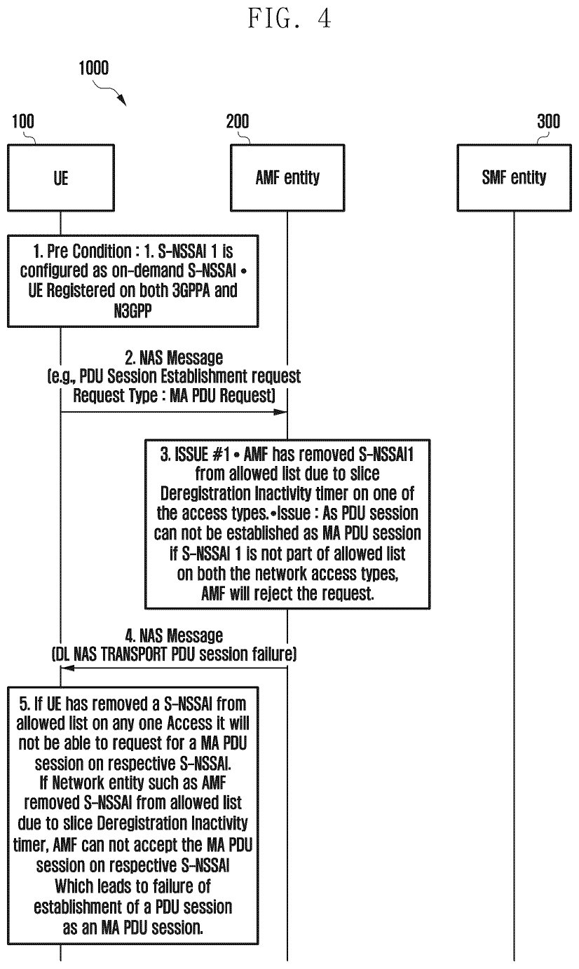

FIG. 4 illustrates Slice Deregistration Inactivity timer running for MA PDU session.

Pre-Condition: At step 1, the UE (100) is registered on both of the Network access types, and configured S-NSSAI1 as on demand S-NSSAI. At step 2, the UE (100) has sent a NAS message for example PDU Session Establishment request to establish a PDU session as an MA PDU session on one of the network access type. At step 3, the AMF entity (200) checks if UE (100) registered on both 3GPPA and N3GPPA then the requested S-NSSAI(e.g. S-NSSAI1) is part of allowed list on both the access types, if network entity(network function) such as AMF entity (200) removed S-NSSAI1 from allowed list on one of the access due to slice Deregistration Inactivity timer. Network entity such as for example AMF entity (200), Will not be able to accept the PDU session as an MA PDU session and thus sends a NAS message such as DL NAS TRANSPORT and indicates failure of the PDU Session Establishment (at step 4). Issue (at step 5):
1. If UE (100) has removed a S-NSSAI from allowed list on any one Access it will not be able to request for a MA PDU session on respective S-NSSAI.
2. If Network entity such as AMF entity (200) removed S-NSSAI from allowed list due to slice Deregistration Inactivity timer, AMF entity (200) cannot accept the MA PDU session on respective S-NSSAI.
3. Which leads to failure of establishment of a PDU session as an MA PDU session.

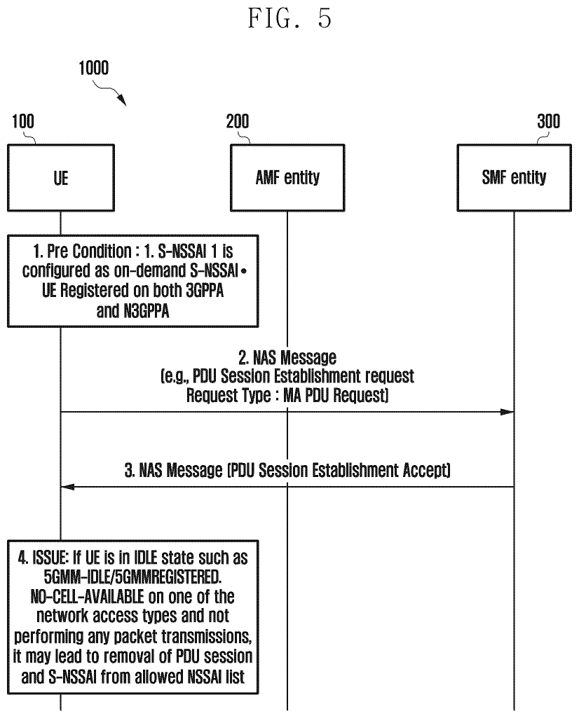

FIG. 5 illustrates PDU session Inactivity timer running for MA PDU session.

Pre-Condition: At step 1, the UE (100) is registered on both of the Network access types, and configured S-NSSAI1 as on demand S-NSSAI. At step 2, UE (100) has sent a NAS message for example PDU Session Establishment request to establish a PDU session as an MA PDU session on one of the network access type. Network entity such as SMF entity (300) has accepted the request, by sending PDU session establishment accept and PDU session is established as an MA PDU session (At step 3). Issue (At step 4):
1. If UE (100) is in IDLE state such as 5GMM-IDLE/5GMM-REGISTERED. NO-CELL-AVAILABLE on one of the network access types and not performing any packet transmissions, it may lead to removal of PDU session (Due to PDU Session Inactivity timer) and S-NSSAI from allowed NSSAI list (Due to removal last PDU session on that S-NSSAI).
2. If the ATSSS rules limits transmission of user data on only one access type then it may lead to removal of PDU session (Due to PDU Session Inactivity timer) and S-NSSAI from allowed NSSAI list (Due to removal last PDU session on that S-NSSAI).

FIG. 6 illustrates UE (100)/AMF shall start the slice Deregistration Inactivity timer once the last PDU session of an on demand S-NSSAI has been successfully handover to another Access type or RAT or PLMN, according to an embodiment disclosed herein. In contrast to FIG. 1, Precondition: At step 1, UE (100) is registered over one/ both of the Network access types and established a PDU session (e.g., PDU Session ID1) over an on-demand S-NSSAI (e.g., S-NSSAI 1) over a access type such as 3GPPA UE initiated handover of PDU session procedure to hand over the PDU session from one network access (source access) to another network access (Target access, e.g., 3GPPA to N3GPPA), by sending a NAS signalling message such PDU Session Establishment Request with request type as “Existing PDU Session” Network entity such as for example SMF entity (300b), Accepts the PDU Session handover by sending as NAS message such as PDU Session Establishment Accept (At step 3).

At step 4, the UE (100) and the AMF entity (200) shall start the slice Deregistration Inactivity timer on source access associated with S-NSSAI once the last PDU session of an on demand S-NSSAI has been successfully handover or attempted to be handed over to another target Access type or RAT or PLMN or another network instance of core network (last PDU session means, UE doesn't have any PDU session associated with S-NSSAI after the handover).

Please note that the Handover of a PDU Session in above example is given between 3GPP Access to Non 3GPP Access, the solution is applicable for all other cases such as:
1. Handover of a PDU session to non-3GPPA to 3GPPA
2. Handover of a PDU session from 5G RAT to LTE RAT or another RAT or between any two RATs
3. Handover of PDU session between AMF entity (200)/SMF entity (300) of same or different PLMN.
4. Handover procedure can be initiated by the UE (100) or it can be network initiated procedure.

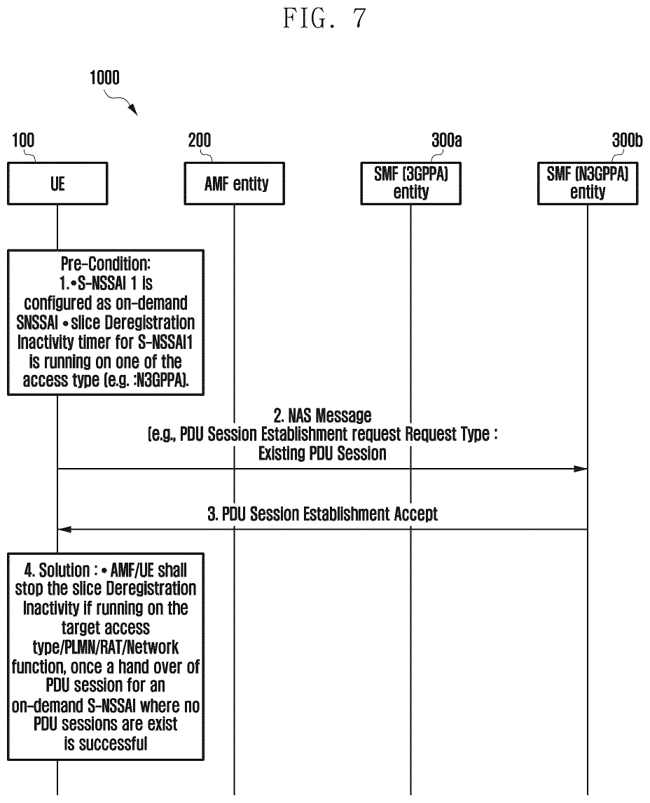

FIG. 7 illustrates proposed solution in which the AMF entity (200)/UE (100) shall stop the inactivity de-registration timer if running on the target access type/ PLMN/RAT/Network entity(network function), according to an embodiment disclosed herein. In contrast to FIG. 2, at step 1, Pre Condition: UE (100) is registered over one/ both of the Network access types, and UE (100) running a slice Deregistration Inactivity timer on one of the network access type for an on demand S-NSSAI (source access e.g., S-NSSAI 1 over N3GPPA)

At step 2, the UE (100) initiates handover of PDU session procedure to hand over the PDU session from one network access (source access) to another network access (target access, e.g., 3GPPA to N3GPPA), by sending a NAS signalling message such PDU Session Establishment Request with request type as “Existing PDU Session”, Network entity such as for example SMF entity (300b), Accepts the PDU Session handover by sending as NAS message such as PDU Session Establishment Accept (At step 3). Solution (At step 4): the AMF entity (200)/the UE (100) shall stop the slice inactivity de-registration timer if running for on demand S-NSSAI on the target access type/PLMN/RAT/Network entity, once a hand over of PDU session for an on-demand S-NSSAI is successful.

Please note that the handover of a PDU Session in above example is given between 3GPP Access to Non 3GPP Access, the solution for all other cases(i.e. when an existing PDU session is transferred) such as
1. Handover of a PDU session from non-3GPPA to 3GPPA.
2. Handover of a PDU session from 5G RAT to LTE RAT or another RAT or between any two RATs.
3. Handover of PDU session between AMF entity (200)/SMF entity (300) of same or different PLMN.
4. Handover procedure can be initiated by the UE (100) or it can be network initiated procedure.

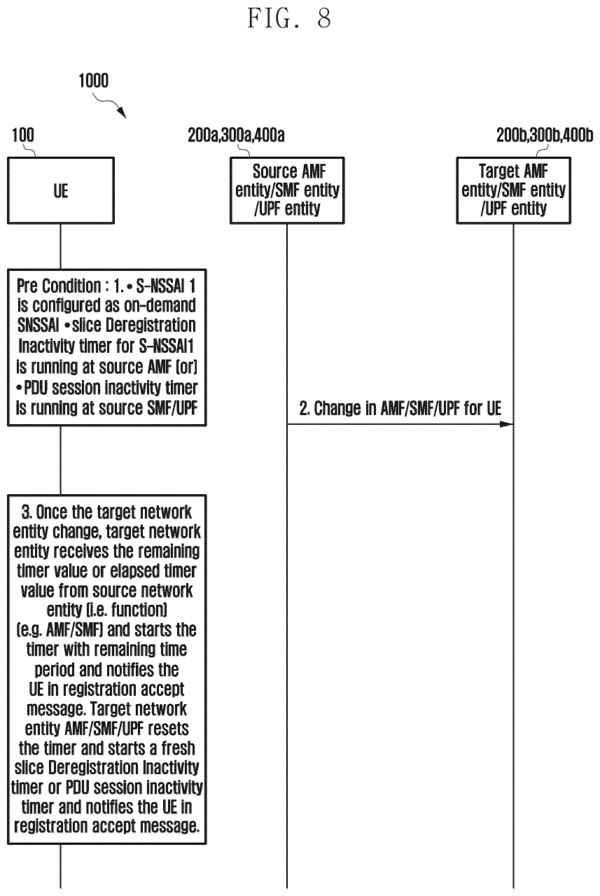

FIG. 8 illustrates proposed solution slice Deregistration Inactivity timer or PDU session inactivity timer and may notifies the UE (100), according to an embodiment disclosed herein. In contrast to FIG. 3, at step 1, Pre-condition: S-NSSAI 1 is configured as on-demand S-NSSAI at the UE (100) and Slice Deregistration Inactivity timer for S-NSSAI1 is running at source AMF entity (200a) and UE (100) (or) PDU session inactivity timer is running at source SMF entity (300a)/UPF entity (400a). The timer in this embodiment is at least one of the below:
1. Slice Deregistration Inactivity timer for each or all S-NSSAI(s) at AMF entity (200a, 200b) and UE (100) (or),
2. PDU session inactivity timer at SMF entity (300a, 300b)/UPF entity (400a, 400b).

At step 2, there is a Change in AMF entity (200)/UPF entity (400)./SMF entity (300) that is serving the UE (100), Solution (at step 3): Once the target network entity change, target network entity receives the remaining timer value or elapsed timer value from source network entity(i.e. function)(e.g. AMF entity (200)/SMF entity (300)) and starts the timer with remaining time period and notifies the UE (100) in registration accept message. Target network entity AMF entity (200)/SMF entity (300)/UPF entity (400b). resets the timer and starts a fresh slice Deregistration Inactivity timer or PDU session inactivity timer and notifies the UE (100) in registration accept message.

Please note that the change of AMF entity (200)/SMF entity (300)/UPF entity (400). can be on same network access or different network access type
1. Change of PDU session from one SMF entity (300)/UPF entity (400). to another SMF entity (300)/UPF entity (400). can be for any reason like load balancing or change in S-NSSAI configuration or similar reason.
2. Change of AMF entity (200) for a UE (100) can be any one of the reason like AMF entity (200) relocation or load balancing or change in UE (100) location or result of registration request of type mobility.
3. Change of AMF entity (200)/SMF entity (300) is from same or different PLMN.

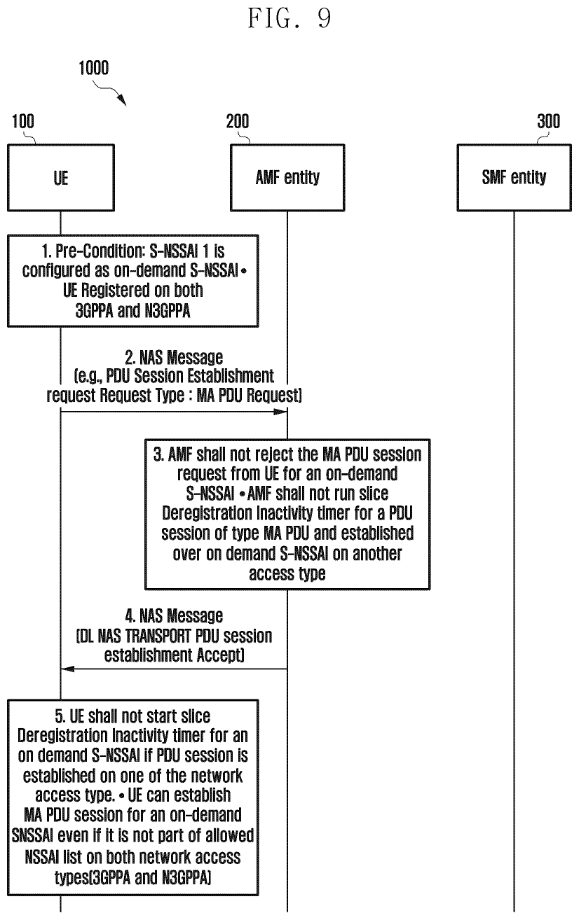

FIG. 9 illustrates proposed solution for Slice Deregistration Inactivity timer not running for MA PDU session, according to an embodiment disclosed herein. In contrast to FIG. 4, at step 1, pre-condition: UE (100) is registered on both of the Network access types, and configured S-NSSAI1 as on demand S-NSSAI. At step 2, UE (100) has sent a NAS message for example PDU Session Establishment request to establish a PDU session as an MA PDU session on one of the network access type. At step 3, AMF entity (200) shall not reject the MA PDU session if the S-NSSAI is marked as on-demand S-NSSAI, but not part of allowed S-NSSAI on both 3GPP and non-3GPPA. Network entity such as for example AMF entity (200) and SMF entity (300), Accepts the PDU session request as MA PDU session and sends PDU Session Establishment Accept (At step 4).
1. The AMF entity (200)/UE shall not start the slice Deregistration Inactivity timer for on-demand S-NSSAI on second network access type, if one of the PDU session is established as MA PDU session on this S-NSSAI and in first network access type even though there is no active PDU session on the second access type. AMF entity (200) and UE (100) will start the slice Deregistration Inactivity timer if on both access at least one PDU session is not established for the case of MA-PDU session (At step 5).

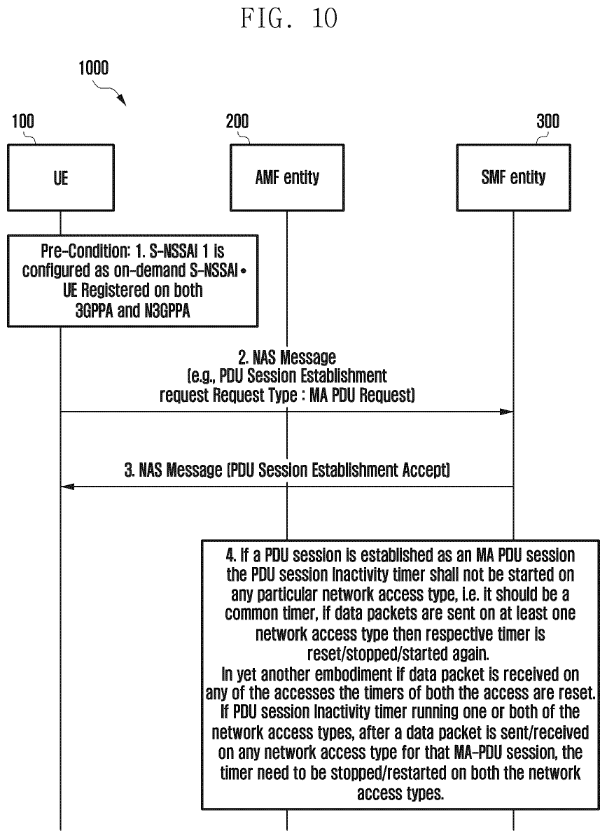

FIG. 10 illustrates PDU session Inactivity timer not running for MA PDU session, according to an embodiment disclosed herein. In contrast to FIG. 5, at step 1. pre Condition: the UE (100) is registered on both of the Network access types, and configured S-NSSAI1 as on demand S-NSSAI. At step 2, UE (100) has sent a NAS message for example PDU Session Establishment request to establish a PDU session as an MA PDU session on one of the network access type. At step 3, Network entity such as SMF entity (300) has accepted the request, by sending PDU session establishment accept and PDU session is established as an MA PDU session.

Solution (at step 4):
1. If a PDU session is established as an MA PDU session the PDU session Inactivity timer shall not be started on any particular network access type, i.e. it should be a common timer, if data packets are sent on at least one network access type then respective timer is reset/stopped/started again.

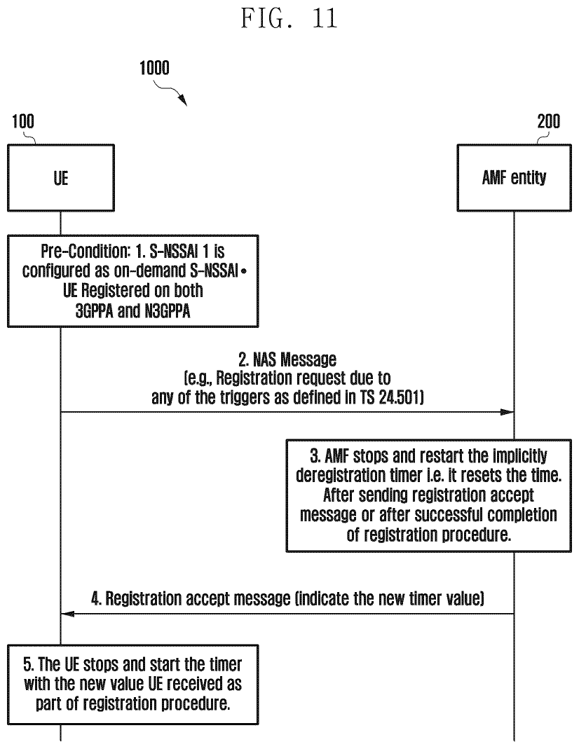

FIG. 11 illustrates Slice Deregistration Inactivity timer running for MA PDU session, according to an embodiment disclosed herein. In contrast to FIG. 5, the UE (100) and the AMF entity (200) adjusts the timer values, NAS Message (e.g., Registration request due to any of the triggers as defined in TS 24.501). Registration accept message (indicate the new timer value), The UE (100) stops and start the timer with the new value UE (100) received as part of registration procedure. AMF entity (200) stops and restart the implicity deregistration timer i.e. it resets the time. After sending registration accept message or after successful completion of registration procedure.

According to one embodiment, at step 1, as a pre-condition, the UE (100) is registered on both of the Network access types, and configured S-NSSAI1 as on demand S-NSSAI. At step 2, UE (100) may transmit a NAS message to the AMF entity (200). The NAS message may comprise a registration request due to any of the triggers as defined in TS 24.50.1
At step 3, the AMF entity (200) may stop and restart the implicitly deregistration timer. According to one embodiment, the AMF entity (200) may reset the time after sending registration accept message or after successful completion of registration procedure.
At step 4, the AMF entity (200) may transmit, to the UE (100), a registration accept message indicating a new timer value.
At step 5, the UE (100) may stop and start the timer with the new value UE received as part of registration procedure.

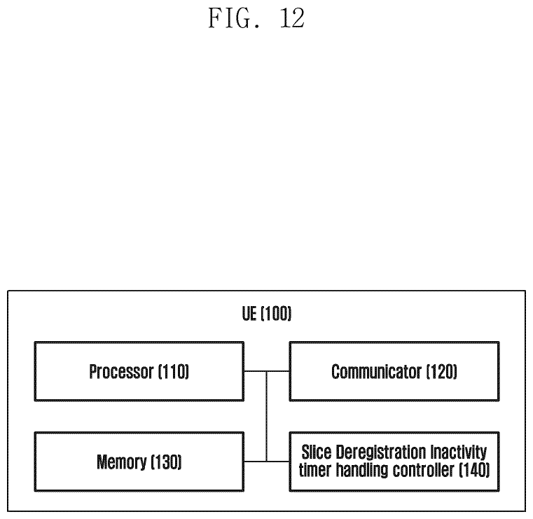

FIG. 12 shows various hardware components of the UE (100), according to the embodiments as disclosed herein. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IOT) device. In an embodiment, the UE (100) includes a processor (110), a communicator (120), a memory (130) and an slice Deregistration Inactivity timer handling controller (140). The processor (110) is coupled with the communicator (120), the memory (130) and the slice Deregistration Inactivity timer handling controller (140).

The slice Deregistration Inactivity timer handling controller (140) determines whether the MA PDU session is successfully established. In an embodiment, the slice Deregistration Inactivity timer handling controller (140) avoids to start the slice de-registration inactivity timer in the UE (100) and the AMF entity (200) on any access type, when the MA PDU session is successfully established. In another embodiment, the slice Deregistration Inactivity timer handling controller (140) starts the slice deregistration inactivity timer for the on-demand S-NSSAI over the corresponding access type, when the MA PDU session is not successfully established.

In an embodiment, the slice Deregistration Inactivity timer handling controller (140) starts the slice Deregistration Inactivity timer on the source access associated with the S-NSSAI when the last PDU session of the on demand S-NSSAI has been successfully handover or attempted to be handed over to a target Access type of the core network.

In an embodiment, the slice Deregistration Inactivity timer handling controller (140) initiates the handover of the PDU session procedure to handover the PDU session from the source network access to the target network access by sending a NAS signalling message with a request type as “existing PDU Session” to the AMF entity (200). Further, the slice Deregistration Inactivity timer handling controller (140) receives the accept message corresponding to the PDU Session handover by sending as NAS message from the AMF entity (200). Further, the slice Deregistration Inactivity timer handling controller (140) stops the slice inactivity de-registration timer if running for on-demand S-NSSAI on the target access type, once the handover of the PDU session for an on-demand S-NSSAI is successful.

The slice Deregistration Inactivity timer handling controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the user equipment (100) and with external devices via one or more networks.

Although the FIG. 12 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

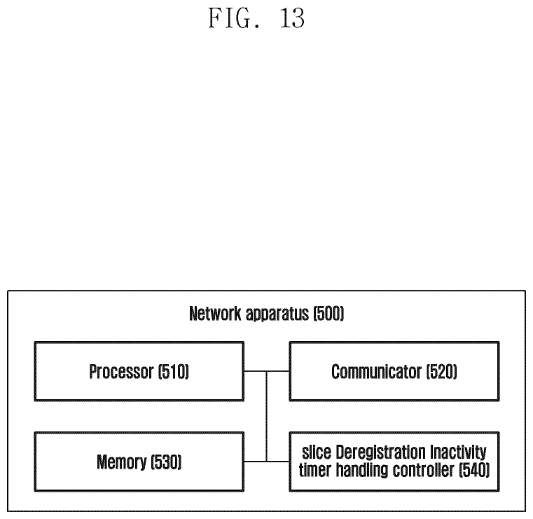

FIG. 13 shows various hardware components of the network apparatus (500), according to the embodiments as disclosed herein. In an embodiment, the network apparatus is one of an AMF entity and a SMF entity.

In an embodiment, the network apparatus (500) includes a processor (510), a communicator (520), a memory (530) and an slice Deregistration Inactivity timer handling controller (540). The processor (510) is coupled with the communicator (520), the memory (530) and the slice Deregistration Inactivity timer handling controller (540).

The slice Deregistration Inactivity timer handling controller (540) determines that the PDU session inactivity timer is common in case of the MA PDU session. Further, the slice Deregistration Inactivity timer handling controller (540) determines that the MA PDU session is established. Further, the slice Deregistration Inactivity timer handling controller (540) avoids to start the PDU session inactivity timer when data is received on any access type in response to determining that the PDU session inactivity timer is common in case of the MA PDU session and the MA PDU session is established.

In an embodiment, the slice Deregistration Inactivity timer handling controller (540) starts the slice Deregistration Inactivity timer on a source access associated with S-NSSAI when a last PDU session of an on demand S-NSSAI has been successfully handover or attempted to be handed over to another target Access type of a core network.

In an embodiment, the slice Deregistration Inactivity timer handling controller (540) sends an accept message corresponding to a PDU Session handover by sending as NAS message to the UE (100) when the UE (100) initiates the handover of a PDU session procedure to hand over a PDU session from a source network access to a target network access by sending the NAS signalling message with a request type as “existing PDU Session” to the network apparatus (500). Further, the slice Deregistration Inactivity timer handling controller (540) stops the slice inactivity de-registration timer if running for on-demand S-NSSAI on the target access type, once the handover of the PDU session for an on-demand S-NSSAI is successful.

The slice Deregistration Inactivity timer handling controller (540) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (510) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (510) may include multiple cores and is configured to execute the instructions stored in the memory (530).

Further, the processor (510) is configured to execute instructions stored in the memory (530) and to perform various processes. The communicator (520) is configured for communicating internally between internal hardware components and with external devices via one or more networks. The memory (530) also stores instructions to be executed by the processor (510). The memory (530) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (530) may, in some examples, be considered a non-transitory storage medium. The term “non-transitory” may indicate that the storage medium is not embodied in a carrier wave or a propagated signal. However, the term “non-transitory” should not be interpreted that the memory (530) is non-movable. In certain examples, a non-transitory storage medium may store data that can, over time, change (e.g., in Random Access Memory (RAM) or cache).

In an embodiment, the communicator (520) includes an electronic circuit specific to a standard that enables wired or wireless communication. The communicator (520) is configured to communicate internally between internal hardware components of the UE (100) and with external devices via one or more networks.

Although the FIG. 13 shows various hardware components of the network apparatus (500) but it is to be understood that other embodiments are not limited thereon. In other embodiments, the network apparatus (500) may include less or more number of components. Further, the labels or names of the components are used only for illustrative purpose and does not limit the scope of the invention. One or more components can be combined together to perform same or substantially similar function in the network apparatus (500).

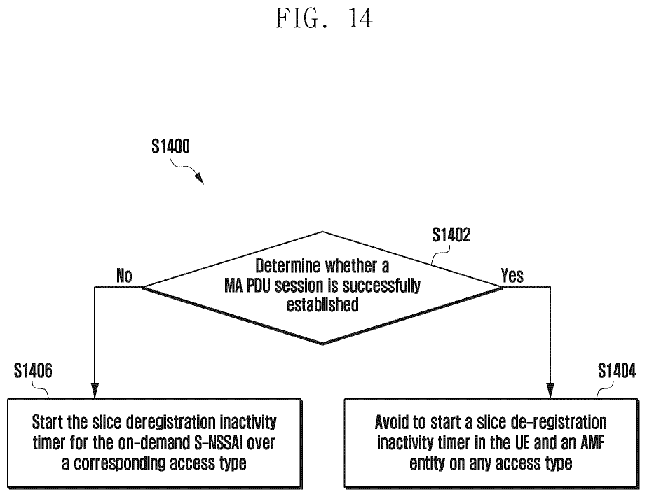

FIG. 14 is a flow chart (S1400) illustrating a method, implemented by the UE (100), for handling the slice Deregistration Inactivity timer of on-demand S-NSSAIs in the telecommunication network (1000), according to the embodiments as disclosed herein. The operations (S1402-S1406) may be handled by the slice Deregistration Inactivity timer handling controller (140).

At S1402, the method includes determining whether the MA PDU session is successfully established. In an embodiment, at S1404, the method includes avoiding to start the slice de-registration inactivity timer in the UE (100) and the AMF entity (200) on any access type, when the MA PDU session is successfully established. In another embodiment, at S1406, the method includes starting the slice deregistration inactivity timer for the on-demand S-NSSAI over the corresponding access type, when the MA PDU session is not successfully established.

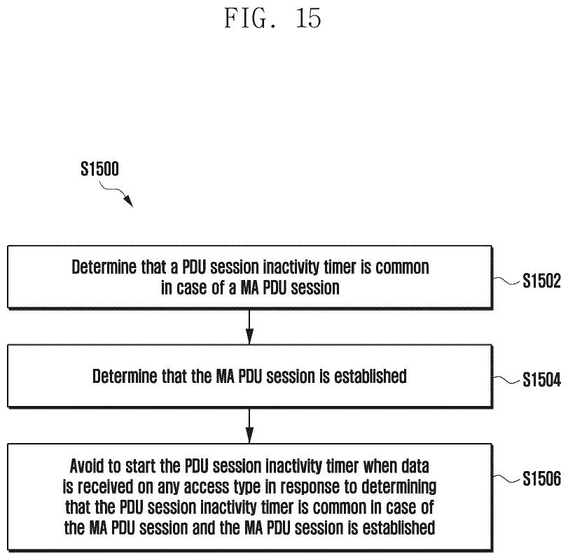

FIG. 15 is a flow chart (S1500) illustrating a method, implemented by the network apparatus (500), for handling the slice Deregistration Inactivity timer of on-demand S-NSSAIs in the telecommunication network (1000), according to the embodiments as disclosed herein. The operations (S1502-S1506) may be handled by the slice Deregistration Inactivity timer handling controller (240).

At S1502, the method includes determining that the PDU session inactivity timer is common in case of the MA PDU session. At S1504, the method includes determining that the MA PDU session is established. At S1506, the method includes avoiding to start the PDU session inactivity timer when data is received on any access type in response to determining that the PDU session inactivity timer is common in case of the MA PDU session and the MA PDU session is established.

The various actions, acts, blocks, steps, or the like in the flow charts (S1400 and S1500) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method performed by a terminal in a wireless communication system, the method comprising:
identifying whether a multi access-protocol data unit (MA PDU) session is established; and
determining to start a slice deregistration inactivity timer for on-demand single network slice selection assistance information (S-NSSAI) over a corresponding access type, in case that the MA PDU session is not established.

2. The method of claim 1, further comprising:
identifying that a handover of a PDU session of the on-demand S-NSSAI is completed to other access type,
wherein the slice deregistration inactivity timer is started.

3. The method of claim 1, further comprising:
transmitting, to an access and mobility management function (AMF) entity, a PDU session establishment request message to establish the PDU session as the MA PDU session on one of access types; and
receiving, from the AMF entity, a response message based on the PDU session establishment request message.

4. A method performed by a core network entity in a wireless communication system, the method comprising:
identifying whether a protocol data unit (PDU) session is established as a multi access-protocol data unit (MA PDU) session; and
determining that a protocol data unit (PDU) session inactivity timer is common for the MA PDU session, in case that the PDU session is established as the MA PDU session.

5. The method of claim 4, further comprising:
determining to avoid to start the PDU session inactivity timer, in case that data is received on any access type in response to determining that the PDU session inactivity timer is common for the MA PDU session and the MA PDU session is established.

6. The method of claim 4, wherein the PDU session inactivity timer is not started on a specific access type.

7. The method of claim 4, further comprising:
transmitting, to a session management function (SMF) entity, a message to report a PDU session inactivity event to cause the SMF entity to release the PDU session, in case that the PDU session inactivity timer is expired before any packet is received or transmitted, based on the PDU session inactivity timer being started.

8. A terminal in a wireless communication system, the terminal comprising:
a transceiver; and
at least one processor is configured to:
identify whether a multi access-protocol data unit (MA PDU) session is established, and
determine to start a slice deregistration inactivity timer for on-demand single network slice selection assistance information (S-NSSAI) over a corresponding access type, in case that the MA PDU session is not established.

9. The terminal of claim 8, wherein the at least one processor is further configured to:
identifying that a handover of a PDU session of the on-demand S-NSSAI is completed to other access type.
wherein the slice deregistration inactivity timer is started.

10. The terminal of claim 8, wherein the at least one processor is further configured to:
transmit, to an access and mobility management function (AMF) entity via the transceiver, a PDU session establishment request message to establish the PDU session as the MA PDU session on one of access types, and
receive, from the AMF entity via the transceiver, a response message based on the PDU session establishment request message.

11. A core network entity in a wireless communication system, the core network entity comprising:
a transceiver; and
at least one processor is configured to:
identify whether a protocol data unit (PDU) session is established as a multi access-protocol data unit (MA PDU) session, and
determine that a protocol data unit (PDU) session inactivity timer is common for the MA PDU session, in case that the PDU session is established as the MA PDU session.

12. The core network entity of claim 11, wherein the at least one processor is further configured to:
determine to avoid to start the PDU session inactivity timer, in case that data is received on any access type in response to determining that the PDU session inactivity timer is common for the MA PDU session and the MA PDU session is established.

13. The core network entity of claim 11, wherein the PDU session inactivity timer is not started on a specific access type.

14. The core network entity of claim 11, wherein the at least one processor is further configured to:
transmit, to a session management function (SMF) entity via the transceiver, a message to report a PDU session inactivity event to cause the SMF entity to release the PDU session, in case that the PDU session inactivity timer is expired before any packet is received or transmitted, based on the PDU session inactivity timer being started.
